(19) United States
(12) Patent Application Publication
(10) Pub. No.: US 2007/0053590 A1
(43) Pub. Date: Mar. 8, 2007

(54) Image recognition apparatus and its method

(76) Inventor: Tatsuo Kozakaya, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/504,597

(22) Filed: Aug. 16, 2006

(30) Foreign Application Priority Data
Sep. 5, 2005 (JP) 2005-257100

(51) Int. Cl. G06K 9/00

(52) U.S. Cl. 382/181

(57) ABSTRACT

An image recognition method or apparatus, the method comprising: inputting an image containing an object to be recognized; creating an input subspace from the inputted image; storing a model subspace to represent three-dimensional object models respectively for different environments; projectively transforming the input subspace in a manner to suppress an element common between the input subspace and the model subspace and thereby suppress influence due to environmental variation, into an environment-suppressing subspace; storing dictionary subspaces relating to registered objects; calculating a similarity between the environment-suppressing subspace and the dictionary subspace; and identifying the object to be recognized as one of the registered objects corresponding to the dictionary subspace having similarity exceeding a threshold.

### CROSS REFERENCE TO RELATED APPLICATIONS

This application is based upon and claims the benefit of priority from the prior Japanese Patent Application No. 2005-257100, filed on Sep. 5, 2005; the entire contents of which are incorporated herein by reference.

### TECHNICAL FIELD

The present invention relates to an apparatus and a method for recognition of a person or object in high precision; in which, for each person or object, variations due to its environments are suppressed by use of an environment dictionary in which learning is previously carried out.

### BACKGROUND OF THE INVENTION

Recognition using a face image is a very useful technique in security since, unlike a physical key or a password, there is no fear of loss or oblivion. However, the face image of a person to be recognized is also variously changed or varied by receiving influence of the variations of environmental conditions such as illumination. Thus, in order to perform the recognition with high precision, it is necessary to have a mechanism to absorb the environmental variations and to extract differences between individuals.

According to SOUMA and NAGAO (Masanori Souma, Kenji Nagao, “Robust Face Recognition under Drastic Changes of Conditions of Image Acquisition”, Transactions: the Institute of Electronics Information and Communication Engineers of Japan or SINGAKURON D-II, Vol. J80-D-II, No. 8, 2225-2231, 1997), when two distinct groups of images taken respectively under two different conditions of image acquisition (photographing environment such as an illumination condition) are obtained, those two groups of images or the conditions are taken account in image recognition, so as to achieve image recognition robust against such environmental variations. However, in many situations, the conditions or environments on the image acquisition are not available on beforehand. Thus, it is difficult to prepare on beforehand the face images photographed under such different conditions or environments; and therefore, situations to which the method is applicable is rather limited.

According to FUKUI et al (Kazuhiro Fukui, Osamu Yamaguchi, Kaoru Suzuki, Ken-ichi Maeda, “Face Recognition under Variable Lighting Condition with Constrained Mutual Subspace Method—Learning of Constraint Subspace to Reduce Influence of Lighting Changes—”, Transactions: the Institute of Electronics Information and Communication Engineers of Japan D-II Vol. J82-D-II, No. 4, 613-620, 1999), with respect to images photographed under plural different environmental conditions, a difference subspace is calculated for each of the photograph environments, and further; a difference subspace is calculated also with respect to a variation component in respect of an individual; a constraint subspace is calculated from those difference subspaces; and a dictionary and an input are projected onto this constraint subspace, so that the environmental variations and variations in respect of same individual are suppressed when to recognize the individual. Also with respect to the case where the environmental variations are not known, when the constraint subspace is constructed from images photographed under various environments, robust recognition can be performed. However, in order to cope with various environmental variations, it is necessary to collect images photographed under various environmental variations. It takes much labor to collect such various images. Further, since the collected images include not only the environmental variations but also the personal variations, it is difficult to extract only the environmental variations and to suppress them.

According to JP-2003-323622A (Japanese Patent Application Publication (KOKAI) No. 2003-323622), a face image is superimposed on prestored three-dimensional shape information to form a face model; and variations of illumination and the like are added to registered images on beforehand; so as to achieve recognition robust against the environmental variation of an input image. However, it would be difficult to correctly represent an illumination variation under an ordinary environment by computer graphics (hereinafter referred to as “CG”) or the like; thus, even if an illumination variation is added to the registered image, the illumination variation same as the input image that is photographed under the ordinary environment may not be represented. Besides, since there is no mechanism to suppress the created variation, a similarity to an image of another person to which the same processing has been applied becomes high, and there is a possibility that erroneous recognition is caused.

As described above, in order to cope with the environmental variations of the recognition object, it is useful to collect or create images involved with various environmental variations. However, such conventional methods have drawbacks or restriction in that; the environmental variations must be known ones, the collection requires excessive labor, and a mechanism to suppress the created variations is lacking.

In view of the above drawbacks of conventional technique, it is aimed to provide an image recognition apparatus and its method in which environmental variations are suppressed and recognition can be performed with high precision.

### BRIEF SUMMARY OF THE INVENTION

According to embodiments of the present invention, an image recognition apparatus comprising: an image input unit configured to input an image containing an object to be recognized; an input subspace creation unit configured to create an input subspace from the input image; an environment dictionary configured to store a model subspace to represent three-dimensional recognition object models under plural different environmental conditions; an environment transformation unit configured to perform a projective transformation of the input subspace to suppress an element common between the input subspace and the model subspace and to obtain an environment suppression subspace in which an influence due to an environmental variation is suppressed; a registration dictionary configured to store dictionary subspaces relating to registered objects; a similarity calculation unit configured to calculate a similarity between the environment suppression subspace or a secondary environment-suppressing subspace derived therefrom and the dictionary subspace; and a recognition unit configured to identify the object to be recognized as one of the registered object corresponding to the dictionary subspace having a similarity exceeding a threshold.

According to embodiments of the present invention, only the influence due to the environmental variation is removed and recognition can be performed with high precision.

### BRIEF DESCRIPTION OF THE DRAWINGS

FIG. 1 is a block diagram showing a structure of a first embodiment.

FIG. 2 is a flowchart of the first embodiment.

FIG. 3 is a view showing an example in which an environmental variation is applied to three-dimensional shape information.

FIG. 4 is a block diagram showing a structure of a second embodiment of the invention.

FIG. 5 is a block diagram showing a structure of a third embodiment of the invention.

FIG. 6 is a block diagram showing a structure of a first modified example of the invention.

FIG. 7 is a block diagram showing a structure of a second modified example of the invention.

### DETAILED DESCRIPTION OF THE INVENTION

### First Embodiment

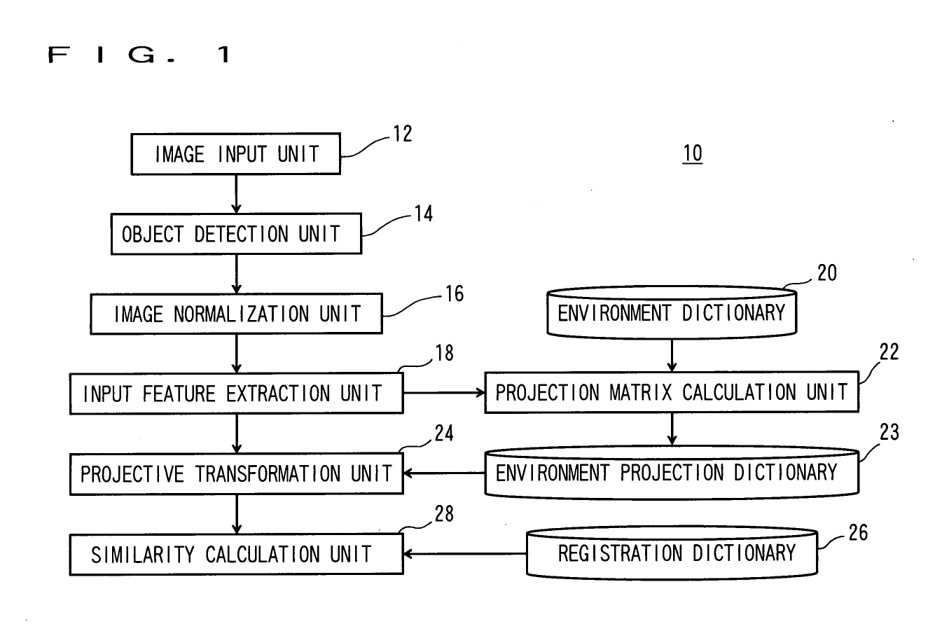

Hereinafter, an image recognition apparatus 10 of a first embodiment of the invention will be described with reference to FIGS. 1 to 3.

(1) Structure of the Image Recognition Apparatus 10

FIG. 1 is a view showing the structure of the image recognition apparatus 10.

As shown in FIG. 1, the image recognition apparatus 10 includes: an image input unit 12 to input a face of a person as an object to be recognized; an object detection unit 14 to detect the face of the person from an inputted image; an image normalization unit 16 to create a normalized image from the detected face; an input feature extraction unit 18 to extract a feature quantity used for recognition; an environment dictionary 20 having information relating to environmental variations, a projection matrix calculation unit 22 to calculate, from the feature quantity and the environment dictionary 20, a matrix for projection onto a subspace to suppress an environmental variation; an environment projection dictionary 23 to store the calculated projection matrix; a projective transformation unit 24 to perform a projective transformation; a registration dictionary 26 in which a dictionary feature quantities relating to faces of persons are registered on beforehand; and a similarity calculation unit 28 to calculate similarities relative to the dictionary feature quantities.

The functions of all the above units 12, 14, 16, 18, 22, 24 and 28 of the image recognition apparatus 10 are realized by a program stored in a computer.

(2) Operation of the Image Recognition Apparatus 10

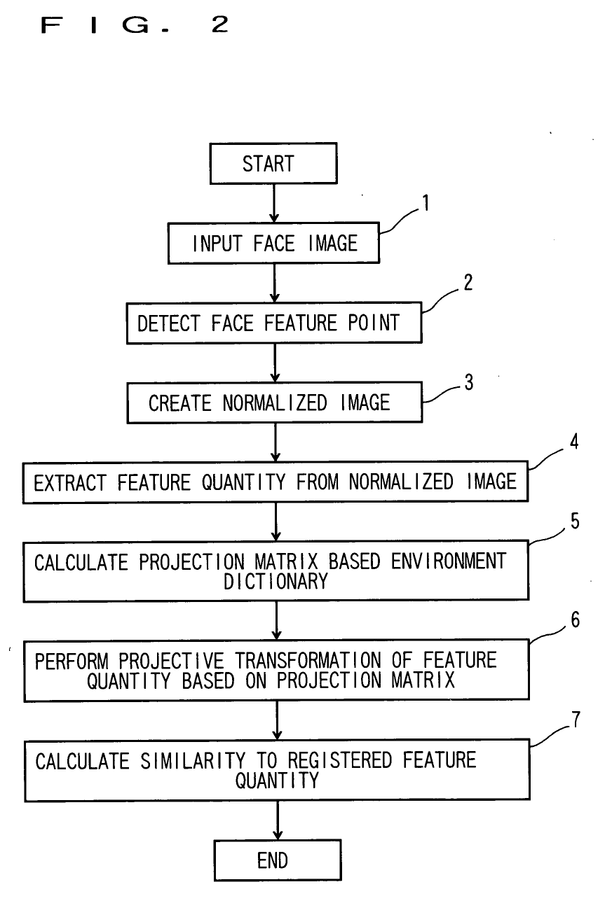

Next, the operation of the image recognition apparatus 10 will be described with reference to a flowchart of FIG. 2.

(2-1) Processing of the Image Input Unit 12

At step 1, the image input unit 12 inputs a face image to be processed.

As an apparatus making up the image input unit 12, a USB camera, a digital camera or the like may be employed for example. A recording apparatus, a video tape, a DVD or the like, which stores face image data that have been photographed and saved on beforehand, may be used; and a scanner to scan a face picture may also be used. In otherwise, the image may be inputted through a network or the like. The image obtained by the image input unit 12 is sequentially sent to the object detection unit 14.

(2-2) Processing of the Object Detection Unit 14

At step 2, the object detection unit 14 detects, as a face feature point, the coordinate (xi, yi) of feature point on a part of a person's face, such as on an eye, a nose or a mouth, in the image.

Although any method may be used, the detection of the face feature point may be made by, for example, a method disclosed in FUKUI and YAMAGUCHI (“Facial Feature Extraction Method based on Combination of Shape Extraction and Pattern Matching”, Transactions: the Institute of Electronics Information and Communication Engineers of Japan D-II Vol. J80-D-II, No. 9, p. 2170-2177, 1997).

(2-3) Processing of the Image Normalization Unit 16

At step 3, the image normalization unit 16 generates a normalized image based on the detected face feature points.

With respect to the creation of the normalized image, for example, an affine transformation is used on the basis of the detected coordinates, so that the size and in-plane rotation are normalized. In the case where feature points do not exist on the same plane, and four or more points are detected, the detected part of the face can be accurately normalized to a specified position by a method described below and by using three-dimensional shape information.

First, the face feature point (xi, yi) obtained from the object detection unit 14 and the corresponding face feature point (xi, yi, zi) on the three-dimensional shape are used, and a camera motion matrix “M” is defined by expression (1), expression (2) and expression (3).

In the expressions below, ( x̅, y̅) denotes the centroid of a feature point on an input image, and ( x̅, y̅, z̅) denotes the centroid of a feature point on three-dimensional shape information.
W=[xᵢ− x̅yᵢ− y̅]^{T} (1)
S=[xᵢ′− x̅′yᵢ′− y̅′zᵢ′− z̅′] (2)
W=MS (3)

With respect to expression (3), a generalized inverse matrix “S^{†}” of the above “S” is calculated, so that a camera motion matrix M is calculated (expression (4)).
M=WS^{†} (4)

Next, the normalized image provided by the three-dimensional shape is created from the input image by using the calculated camera motion matrix M. An arbitrary coordinate (x′, y′, z′) on the three-dimensional shape can be transformed into a coordinate (s, t) on the corresponding input image by expression (5).

$$[ \begin{matrix}s \\ t\end{matrix} ] = M [ \begin{matrix}{x}^{′} - {\overline{x}}^{′} \\ {y}^{′} - {\overline{y}}^{′} \\ {z}^{′} - {\overline{z}}^{′}\end{matrix} ] \qquad ( 5 )$$

Accordingly, a pixel value T(x′, y′) of the normalized image corresponding to the coordinate (x′, y′, z′) on the three-dimensional shape is defined by using a pixel value I (x,

y) on the input image and by expression (6).
T(x′,y′)=I(s+ x̅,t+ y̅) (6)

The normalized image can be obtained by calculating, with respect to the expression (5) and the expression (6), all coordinates for the normalized image of the three-dimensional shape.

When the normalization is performed by using the three-dimensional shape information as stated above, the normalized image can be accurately created irrespective of the direction and size of the face. However, the face pattern may be created by using any normalizing method.

Besides, plural normalized images can be created by moving the detected feature point position in an arbitrary direction to perform perturbation, by shifting the image-cropping position, or by rotating or scaling the pattern image. Plural images may be inputted like a video input.

(2-4) Processing of the Input Feature Extraction Unit 18

At step 4, the input feature extraction unit 18 extracts a feature quantity necessary for recognition, based on the created normalized image.

For example, the normalized image is regarded as a feature vector having a pixel value as an element, a generally known K-L expansion is performed, and the obtained orthonormal vectors are made the feature quantity of a person corresponding to the input image. At the time of registration of the person, this feature quantity is recorded.

The way of selecting the element of this feature vector and the creation method thereof may be arbitrarily performed, any image recognition, such as differential processing or histogram equalization, may be performed on the feature vector, and the feature quantity creation method is not limited thereto.

(2-5) Processing of the Projection Matrix Calculation Unit 22

At step 5, the projection matrix calculation unit 22 uses the prestored environment dictionary 20, calculates a projection matrix for projection onto a subspace to suppress an influence due to an environmental variation from the feature quantity created by the input feature extraction unit 18, and stores it in the environment projection dictionary 23.

Although any method may be used for the calculation of the projection matrix, it can be realized by, for example, the method disclosed in the FUKUI et al mentioned in the “Background of the invention”. According to the FUKUI et al, when there are plural feature quantities (subspaces), a constraint subspace obtained from a difference subspace of those is calculated, and a projective transformation is performed, so that two subspaces can be made dissimilar to each other. Hereinafter, for simplification, it will be called “orthogonalization” that the projection matrix onto the subspace to emphasize the difference between feature quantities is calculated as stated above, and the projective transformation is performed. To make subspaces dissimilar to each other means that the evaluation criterion (a distance, an angle or the like defined in the objective subspaces) is maximized or minimized. Incidentally, to obtain an orthogonalized subspace of two subspaces means obtaining a subspace in which an element common to two subspaces is suppressed.

In addition, the projection matrix “O” can be calculated using an expression indicated below.

$$\begin{matrix}{P}_{i} = {\sum }_{j = 1}^{{N}_{C}} {ϕ}_{ij} {ϕ}_{ij}^{T} & ( 7 ) \\ P = \frac{1}{R} ( {P}_{1} + {P}_{2} + … + {P}_{R} ) & ( 8 ) \\ O = {B}_{p} {\ddot{E}}_{p}^{- \frac{1}{2}} {B}_{p}^{T} & ( 9 )\end{matrix}$$

Where, φᵢⱼ denotes a jth orthonormal basis of an ith subspace, Nc denotes the number of base vectors of subspaces, R denotes the number of subspaces (here, since there are an input feature quantity and an environment dictionary, R=2), Bₚ denotes a matrix in which eigenvectors of P are arranged, and Ëₚ denotes a diagonal matrix made of eigenvalues of P.

With respect to the environment dictionary 20, any dictionary may be used as long as an environmental variation to be suppressed is suitably described. Although the term of “environment” or “environmental” is used for convenience, the invention can be applied to not only the variations dependent on environments in respect of illumination variation or the like, but also on “environments” in respect of the aging of a person or alterations due to ornaments such as eyeglasses.

For example, the environment dictionary 20 relating to the illumination variation can be created by a procedure described below.

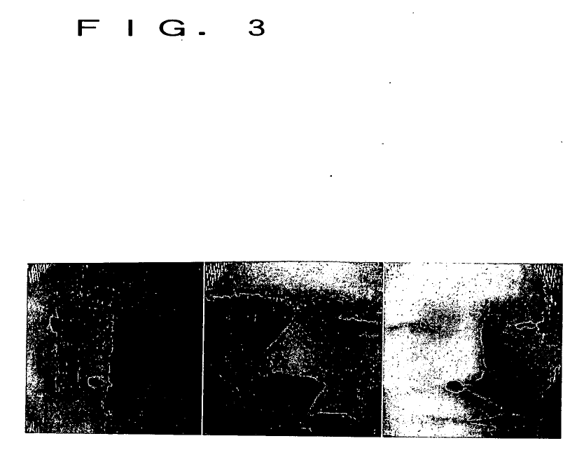

First, three-dimensional shape information created by using the CG technique is used as a model of a face; and based on such model, images which would appear when illuminated from various directions are created by using the CG technique. FIG. 3 shows examples of such images. The creation of the environment dictionary 20 can be performed by an offline processing; and thereby, illumination conditions closer to a prevailing environment can be expressed using an advanced CG technique. With respect to the model of the face, as shown in FIG. 3, in order to decrease differences due to personal features, a face like a plaster figure in which brows, beards and the like are removed is created by the CG technique.

The same processing as in the input feature extraction unit 18 is performed on the obtained CG image, and the extracted feature quantity is registered as the model feature quantity into the environment dictionary 20.

Thus, the model feature quantity stored in the environment dictionary 20, which has been created by using the three-dimensional shape and the CG technique, includes only those of necessary environmental variations; and accordingly, an influence is not given to personal features necessary for recognition. Besides, the three-dimensional shape used for the creation of the normalized image can also be used for the creation of the model feature quantity of the environment dictionary 20.

By using the three-dimensional shape common between the normalized image and that of the model feature quantity of the environment dictionary 20, the illumination variation of the normalized image is represented more suitably into the model feature quantity of the environment dictionary 20.

With respect to environmental variations other than the illumination variation, similarly, plural images relating to the environmental variations are collected on beforehand; and the above procedure is performed, so that the model feature quantity to be stored in the environment dictionary 20 is created.

(2-6) Processing of the Projective Transformation Unit 24

At step 6, the projective transformation unit 24 performs a projective transformation of the inputted feature quantity, based on the projection matrix obtained by the projection matrix calculation unit 22; and creates a feature quantity (hereinafter referred to as an environment suppression feature quantity) in which the influence due to the environmental variation is suppressed. The recognition is performed using the environment suppression feature quantity in which the projective transformation has been performed.

(2-7) Processing of the Similarity Calculation Unit 28

At step 7, the similarity calculation unit 28 calculates the similarity between the dictionary feature quantity relating to the face of the person stored in the registration dictionary 26 and the environment suppression feature quantity calculated by the projective transformation unit 24. At this time, it is assumed that also with respect to the registration dictionary 26, the projective transformation has been performed similarly to the inputted feature quantity.

With respect to the similarity calculation, any method may be used, and for example, a mutual subspace method may be used which is the base of the constraint mutual subspace method described in the FUKUI et al mentioned in the “Background of the invention”. The similarity of the face feature quantities can be calculated by such a recognition method. The similarity is judged by a predetermined threshold, and the person is identified. The threshold may be a value determined by a previous recognition experiment or the like, or can also be increased/decreased according to the feature quantity of the person.

(3) Effects of the First Embodiment

As stated above, according to the image recognition apparatus 10 of the first embodiment, the previously created environment dictionary 20 is used, so that only the influence due to the environmental variation is removed without damaging the feature to represent the personality important for the recognition, and the recognition can be performed with high precision.

### Second Embodiment

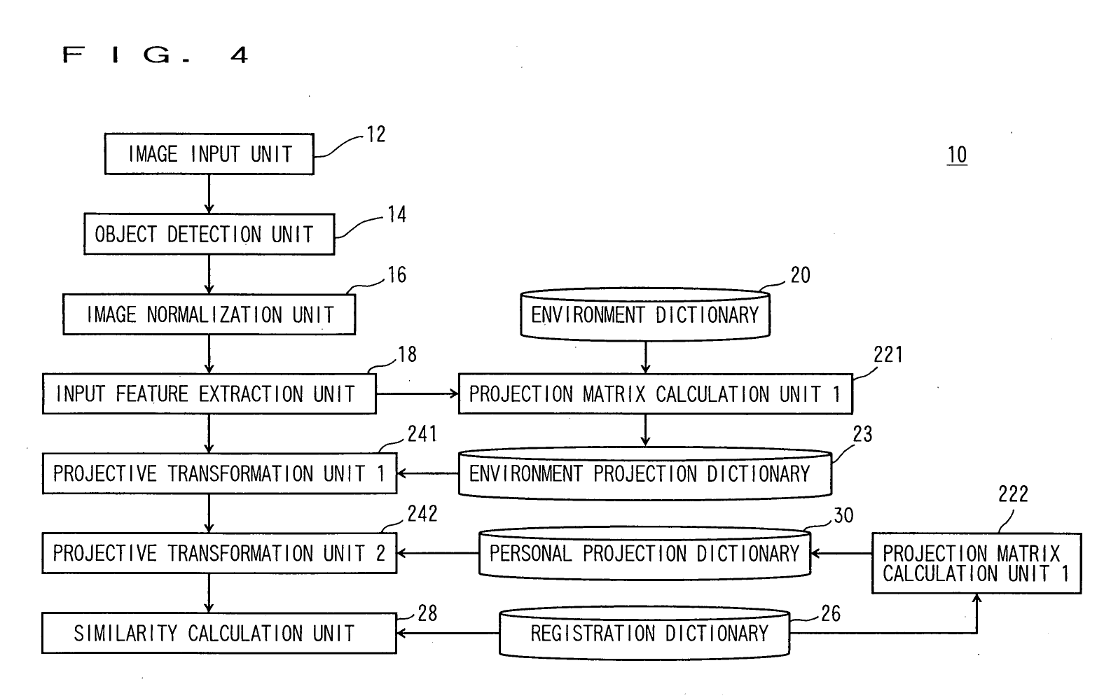

Next, an image recognition apparatus 10 of a second embodiment of the invention will be described with reference to FIG. 4.

(1) Structure of the Image Recognition Apparatus 10

FIG. 4 is a view showing the structure of the image recognition apparatus 10.

The image recognition apparatus 10 includes: an image input unit 12 to input a face of a person which becomes an object; an object detection unit 14 to detect the face of the person from an inputted image; an image normalization unit 16 to create a normalized image from the detected face; an input feature extraction unit 18 to extract a feature quantity used for recognition; an environment dictionary 20 having information relating to environmental variations; a first projection matrix calculation unit 221 to calculate a matrix for projection onto a subspace to suppress an environmental variation from the feature quantity and the environment dictionary 20; an environment projection dictionary 23 to store the calculated projection matrix; a first projective transformation unit 241 to perform a projective transformation to suppress the environmental variation; a second projection matrix calculation unit 222 to calculate a matrix for projection onto a space to emphasize a personal difference by using a pre-registered registration dictionary 26; a second projective transformation unit 242 to perform a projective transformation to emphasize the personal difference; and a similarity calculation unit 28 to calculate a similarity to the pre-registered registration dictionary 26.

(2) Operation of the Image Recognition Apparatus 10

The image input unit 12, the object detection unit 14, the image normalization unit 16, the environment dictionary 20, the input feature extraction unit 18, the registration dictionary 26, and the similarity calculation unit 28 are the same as those described in the first embodiment.

The first projection matrix calculation unit 221 and the first projective transformation unit 241 are identical to the projection matrix calculation unit 22 and the projective transformation unit 24 described in the first embodiment. The feature quantity, in regard to the input obtained from the input feature extraction unit 18, and the environment dictionary 20 are orthogonalized and an environment suppression feature quantity is obtained.

In the second projection matrix calculation unit 222, the prestored registration dictionary 26 is used, and the environment suppression feature quantity obtained by the first projective transformation unit 241 is orthogonalized to emphasize a personal difference and is registered in the personal projection dictionary 30.

The second projection matrix calculation unit 222 may employs the method of the FUKUI et al mentioned in the “Background of the invention” as similarly to the first projection matrix calculation unit 221, so as to calculate a constraint subspace that is obtained from a difference subspace of the registration dictionary 26, and then is orthogonalized by a projective transformation. In otherwise, processing of expressions (7) to (9) and any other methods may be used to perform the calculation.

At this time, when the registration dictionary 26 is also orthogonalized to the environment dictionary 20 on advance, differently from the conventional method of the FUKUI et al or the like, since the environmental variations are suppressed for both the input feature and the registration dictionary 26, the personal difference useful for recognition can be more effectively extracted.

In the second projective transformation unit 242, with respect to the environment suppression feature quantity obtained from the first projective transformation unit 241, the projective transformation is performed through the projection matrix obtained by the second projection matrix calculation unit 222, and the environment suppression feature quantity to emphasize the personal difference is obtained.

The similarity calculation unit 28 calculates, as similarly to the first embodiment, the similarity between the environment suppression feature quantity to emphasize the personal difference, which is obtained in the second projective transformation unit 242, and the registration dictionary 26.

As stated above, according to the image recognition apparatus 10 of the second embodiment, the previously created environment dictionary 20 is used to suppress the environmental variations for each individual, and further, the space to emphasize the personal difference is created from the registration dictionaries, and therefore, the recognition can be performed with high precision.

### Third Embodiment

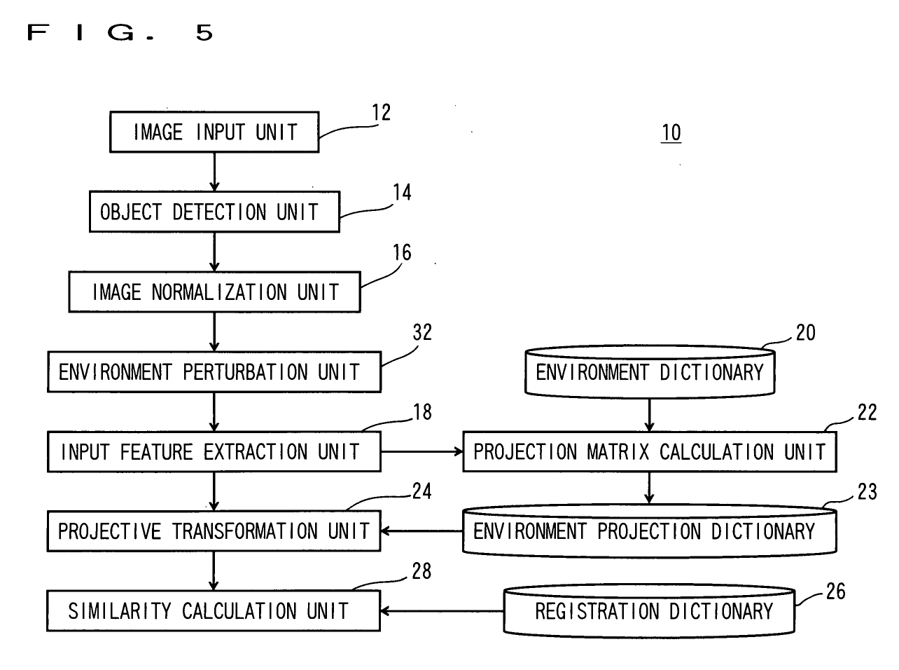

Next, an image recognition apparatus 10 of a third embodiment of the invention will be described with reference to FIG. 5.

(1) Structure of the Image Recognition Apparatus 10

FIG. 5 is a view showing the structure of the image recognition apparatus 10.

The image recognition apparatus 10 includes: an image input unit 12 to input a face of a person to be recognized, an object detection unit 14 to detect the face of the person from an inputted image; an image normalization unit 16 to create a normalized image from the detected face; an input feature extraction unit 18 to extract a feature quantity used for recognition; an environment perturbation unit 32 to perturb the input image with respect to an environmental variation; an environment dictionary 20 having information relating to environmental variations; a projection matrix calculation unit 22 to calculate a matrix for projection onto a space to suppress an environmental variation from the feature quantity and the environment dictionary 20; an environment projection dictionary 23 to store the calculated projection matrix; a projective transformation unit 24 to perform a projective transformation, and a similarity calculation unit 28 to calculate a similarity to a pre-registered registration dictionary 26.

In this embodiment, as compared with the first embodiment, the environment perturbation unit 32 is added, and the other operation is the same as that of the first embodiment.

(2) Operation of the Environment Perturbation Unit 32

Next, the operation of the environment perturbation unit 32 will be described.

The environment perturbation unit 32 artificially imparts environmental variations onto the inputted image, and creates plurality of input environmental variation images from the plural environmental variations.

The environmental variations to be imparted are preferably same kind of variations with those in the environment dictionary 20; while the other kind of environmental variation may also be imparted. When to impart the environmental variations to the inputted image, following method may be used for example, while any other method may be used.

First, an image is prepared which has been subjected to the normalization processing by the image normalization unit 16 and imparted with an environmental variation. This may be such image as shown in FIG. 3, which has been used at the time of creation of the environment dictionary 20.

The normalized image obtained by the image normalization unit 16 and the foregoing normalized image imparted with the environmental variation are subjected to the same normalization processing so that pixel-by-pixel correspondence is established between the two images. Thus, when integration is simply performed for each pixel, a renewed or secondary normalized image imparted with the environmental variation (illumination variation in the case of FIG. 3) is obtained.

Plural such normalized images imparted with environmental variations are prepared. That is, the perturbation is performed with respect to the environmental variations, so that plural renewed or secondary normalized images are created from one inputted and normalized image.

The method of perturbation relating to the environmental variations is not limited to this. For example, Principal Component Analysis is previously performed on an image relating to an environmental variation, and a perturbed image may be obtained from a linear combination of the principal components. Alternatively, the environmental variations may be added or imparted to an image that is partly masked. The feature quantity stored in the registration dictionary 26 is also subjected to the processing same as the input feature quantity that is inputted to the environment perturbation unit 32.

Hence, according to the image recognition apparatus 10 of the third embodiment, the environment perturbation is applied to both the feature quantity of the input and the feature quantity of the registration dictionary 26. Thus, even in the case where a lopsidedness in the environmental variations occurs in one of them, the environmental variations of both can be kept as uniform as possible; and information relating to the personality is kept in the subsequent projective transformation using the environment dictionary 20, so that recognition can be performed with high precision.

### MODIFIED EXAMPLES

The present invention is not limited to the hereto-mentioned embodiments, and may be embodied while modifying the elements in accordance with actual usage, within the scope of the invention. Besides, various combinations of the elements disclosed in the embodiments may be adopted in accordance with actual usage or requirement. For example, some elements may be omitted from the set of elements appeared in one of the embodiments. Further, the elements appeared in different embodiments may be combined in accordance as situation or requirement arises.

### (1) Modified Example 1

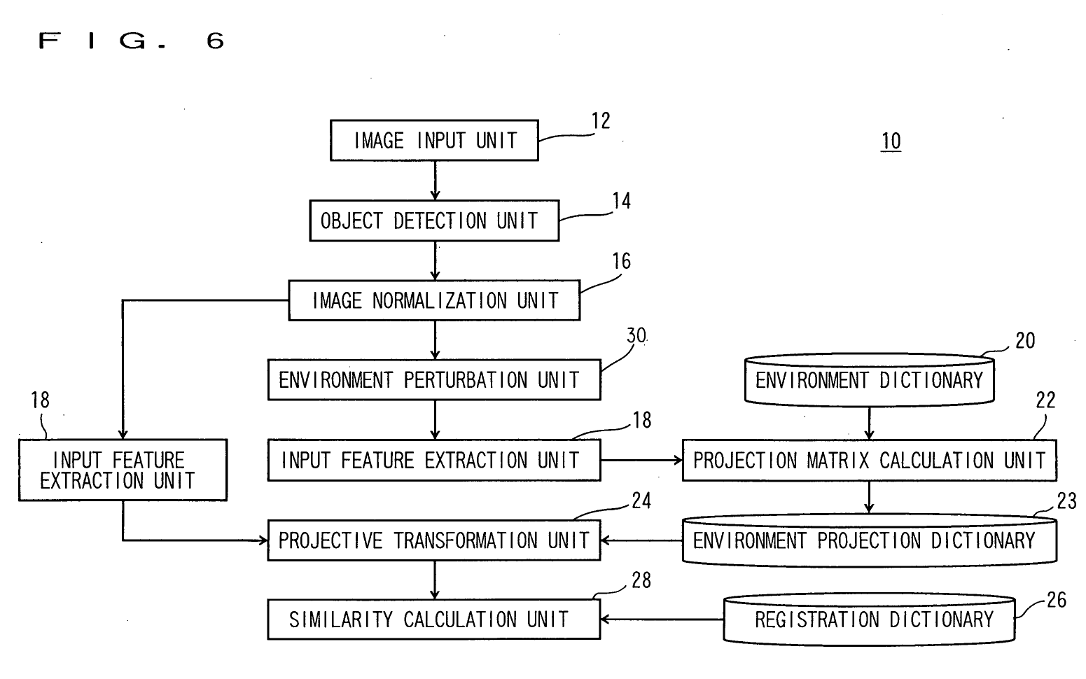

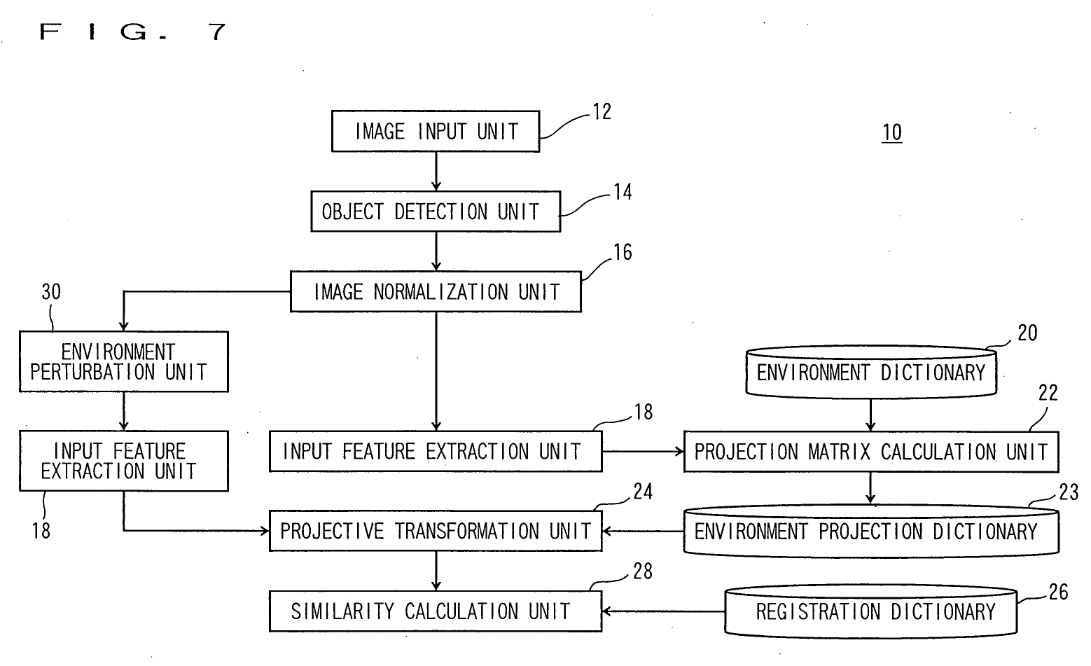

Modified example 1 will be described with reference to FIGS. 6 and 7.

In the third embodiment, the feature quantity delivered to the projection matrix calculation unit 22 and the feature quantity delivered to the projective transformation unit 24 are identical to each other, and the environmental perturbation is applied or imparted to both of them. However, applying or not of the environment perturbation may be arbitrarily selected with respect to each of the two feature quantities; that is, the feature quantity to be used for the creation of the projection matrix to the environment dictionary 20, and the feature quantity to be subjected to the projective transformation and is used for recognition.

FIGS. 6 and 7 are structural views of the cases where the way of application of environment perturbation is modified.

In a detailed modified example shown in FIG. 6, the similarity is calculated after that; the environment perturbation is applied only to the feature quantity that is used in the projection matrix calculation using the environment dictionary 20. Thus, the environment perturbation is not applied to the feature quantity that is subjected to the projective transformation using the environment projection dictionary.

In an detailed modified example shown in FIG. 7, the similarity is calculated after that; the environment perturbation is applied only to the feature quantity that is subjected to the projective transformation using the environment projection dictionary.

### (2) Modified Example 2

A modified example 2 will be described.

As in the first embodiment, the environment dictionary relating to the illumination variation is prepared and is used in the projective transformation. In addition to this, another environment dictionary relating to an aging variation is also prepared and is additionally used in the projective transformation.

Besides, one or plurality of further environment dictionaries may be prepared so that; the projective transformation is performed at many stages, and the environmental variation is further suppressed.

What is claimed is:

1. An image recognition apparatus comprising:
an image input unit configured to input an image containing an object to be recognized;
an input subspace creation unit configured to create an input subspace from the input image;
an environment dictionary configured to store a model subspace to represent three-dimensional recognition object models under plural different environmental conditions;
an environment transformation unit configured to perform a projective transformation of the input subspace to suppress an element common between the input subspace and the model subspace and to obtain an environment suppression subspace in which an influence due to an environmental variation is suppressed;
a registration dictionary configured to store dictionary subspaces relating to registered objects;
a similarity calculation unit configured to calculate a similarity between the environment suppression subspace or a secondary environment-suppressing subspace derived therefrom and the dictionary subspace; and
a recognition unit configured to identify the object to be recognized as one of the registered object corresponding to the dictionary subspace having a similarity exceeding a threshold.

2. The apparatus according to claim 1, further comprising a dictionary transformation unit configured to perform a projective transformation of the environment suppression subspace to suppress an element common among the dictionary subspaces and to obtain the secondary environment-suppressing subspace in which a difference between the registered objects is exaggerated.

3. The apparatus according to claim 1, the input subspace creation unit comprising a feature point detection unit configured to extract a feature point of the object from the input image,
wherein the input subspace creation unit configured to create the input subspace from the feature point.

4. The apparatus according to claim 1, wherein the plural environmental conditions are related to variation of illumination and/or aging or time-wise change of the object.

5. The apparatus according to claim 1, wherein the similarity calculation unit employs an angle between the environment suppression subspace and the dictionary subspace as the similarity.

6. The apparatus according to claim 1, further comprising an environment perturbation unit configured to impart an environmental variation to the input image for creation of the input subspace and also to an image for creation of the dictionary subspace.

7. The apparatus according to claim 1, wherein the dictionary transformation unit obtains a projection matrix to enlarge a difference between the dictionary subspaces, uses this projection matrix to perform a projective transformation of the environment suppression subspace and obtains the secondary environment-suppressing subspace.

8. An image recognition method comprising:
inputting an image containing an object to be recognized;
creating an input subspace from the inputted image;
storing a model subspace to represent three-dimensional object models respectively for different environments;
projectively transforming the input subspace in a manner to suppress an element common between the input subspace and the model subspace and thereby suppress influence due to environmental variation, into an environment-suppressing subspace; storing dictionary subspaces relating to registered objects;
calculating a similarity between the environment-suppressing subspace or a secondary environment-suppressing subspace derived therefrom and the dictionary subspace; and
identifying the object to be recognized as one of the registered objects corresponding to the dictionary subspace having similarity exceeding a threshold.

9. The method according to claim 8, further comprising: projectively transforming the environment-suppressing subspace, in a manner to suppress an element common among the dictionary subspaces and thereby exaggerate difference among the registered objects, into a secondary environment-suppressing subspace, which is then used in said calculating of the similarity.

10. The method according to claim 8, said creating of the input subspace comprising: extracting a feature point of the object from the inputted image, and creating the input subspace from the feature point.

11. The method according to claim 8, wherein the different environments are related to variation of illumination and/or aging or time-wise change of the object.

12. The method according to claim 8, wherein an angle between the environment-suppressing subspace and the dictionary subspace is taken as the similarity.

13. The method according to claim 8, wherein an environmental variation is imparted to the inputted image for creation of the input subspace and also to an image for creation of the dictionary subspace.

14. The method according to claim 8, further comprising;
obtaining a projection matrix enlarging a difference between the dictionary subspaces; and
projectively transforming the environment-suppressing subspace into the secondary environment-suppressing subspace by use of the projection matrix.

15. A program product for realizing image recognition by a computer, the program product comprising instructions of:
inputting an image containing an object to be recognized;
creating an input subspace from the inputted image;
storing a model subspace to represent three-dimensional object models respectively for different environments;
projectively transforming the input subspace in a manner to suppress an element common between the input subspace and the model subspace and thereby suppress influence due to environmental variation, into an environment-suppressing subspace;
calculating a similarity between the environment-suppressing subspace or a secondary environment-suppressing subspace derived therefrom and the dictionary subspace; and
identifying the object to be recognized as one of the registered objects corresponding to the dictionary subspace having similarity exceeding a threshold.

16. The program product according to claim 15, further comprising instruction of: projectively transforming the environment-suppressing subspace, in a manner to suppress an element common among the dictionary subspaces and thereby exaggerate differences among the registered objects, into a secondary environment-suppressing subspace, which is then used in said calculating of the similarity.

17. The program product according to claim 15, said creating of the subspace comprising: extracting a feature point of the object from the inputted image, and creating the input subspace from the feature point.

18. The image recognition program product according to claim 15, wherein the different environments are related to variation of illumination and/or aging or time-wise change of the object.

19. The image recognition program product according to claim 15, wherein an angle between the environment-suppressing subspace and the dictionary subspace is taken as the similarity.

20. The image recognition program product according to claim 15, wherein an environmental variation is imparted to the inputted image for creation of the input subspace and also to an image for creation of the dictionary subspace.

21. The image recognition program product according to claim 15, further comprising instructions of;
obtaining a projection matrix enlarging a difference between the dictionary subspaces; and
projectively transform the environment-suppressing subspace into the secondary environment-suppressing subspace by use of the projection matrix.
